(19) United States
(12) Patent Application Publication
(10) Pub. No.: US 2025/0046192 A1
(43) Pub. Date: Feb. 6, 2025

(54) METHOD AND ASSISTANCE SYSTEM FOR SUPPORTING A LANE CHANGE MANEUVER, AND MOTOR VEHICLE

(71) Applicant: VOLKSWAGEN AKTIENGESELLSCHAFT, Wolfsburg (DE)

(72) Inventors: Daniel Münning, Braunschweig (DE); Thomas Strehlow, Braunschweig (DE)

(21) Appl. No.: 18/714,697

(22) PCT Filed: Nov. 30, 2022
(86) PCT No.: PCT/EP2022/083865

§ 371 Date: May 30, 2024

(30) Foreign Application Priority Data
Nov. 30, 2021 (DE) 10 2021 213 571.4

(51) Int. Cl. G08G 1/16; B60W 30/18

(52) U.S. Cl. CPC G08G 1/167; B60W 30/18163; B60W 2420/408; B60W 2520/10; B60W 2552/30; B60W 2554/4042; B60W 2554/406; B60W 2554/802

(57) ABSTRACT

A method and an assistance system support a lane change by a motor vehicle. In the method, objects detected by a rearward-directed environment sensor system are each assigned to a direction lane of a road on which the motor vehicle is travelling. The direction lane assignment is classified as stable when no switch has occurred for at least a predefined time-period in the object-specific direction lane assignments. A classification as unstable is made as soon as such a switch occurs. As-long-as the direction lane assignment is classified as stable, a lane change by the motor vehicle from the currently travelled lane to an adjacent lane is supported taking into account only objects assigned to this adjacent lane. If a safe lane change is possible in view of the objects taken into account according to a predefined position criterion, this is signaled automatically to support the lane change.

The present invention relates to a method and an assistance system for supporting a lane change maneuver. The invention also relates to a correspondingly designed motor vehicle.

There are already a variety of different assistance systems for motor vehicles that support a driver in carrying out the driving task or that can at least partially perform the task. However, accidents continue to occur in road traffic and so there remains potential and need for improvement. A significant source of danger can be presented by overtaking and lane change maneuvers in particular. In these cases, an improvement in a support or assistance function can thus contribute particularly effectively to an improvement in overall road safety.

For example, WO 2007/145 564 A1 describes a method for using an automatic lane maintenance system for maintaining a lateral distance between vehicles. Specifically, the document proposes a method for piloting a vehicle, in which objects are detected in lanes adjacent to a lane occupied by the vehicle. The vehicle uses the lane maintenance system. Furthermore, in the method the position of the vehicle within the occupied lane is adjusted relative to a detected object.

An important aspect for improving safety can be the detection of objects in an environment of a particular vehicle. In this connection, WO 2013/129 360 A1 describes a device for three-dimensional object detection. The aim is to record an image of a region behind a vehicle and convert it into a bird's eye view image. Positions of multiple such bird's eye view images taken at different times are then aligned. Based on a frequency distribution of sets of pixels that indicate a deviation in the aligned bird's eye view image, difference waveform information is then generated. Based on this, three-dimensional objects are then detected in a predetermined detection region, wherein the relative position of a three-dimensional object in relation to the vehicle is also detected.

The object of the present invention is to provide support for a driver of a motor vehicle during lane change maneuvers with an improved robustness and availability compared to conventional solutions.

This object is achieved according to the invention by means of the subject matter of the independent claims. Advantageous embodiments and developments of the present invention are disclosed in the dependent claims, the description and the figures.

The method according to the invention is designed, and can thus be used, to support a driver of the motor vehicle during forward travel of the motor vehicle on a road having a plurality of direction lanes, in particular with regard to a possible lane change from a lane on which the vehicle is currently driving to or into at least one detected adjacent lane. Such an adjacent lane may be in particular directly adjacent to the lane currently being driven on. The lane currently being driven on and the at least one adjacent lane are in this case direction lanes of the road, which are intended for the same direction of travel. The method can be used in particular in a manual driving mode of the motor vehicle, hence if it is being manually driven by a driver of the motor vehicle, or in an assisted or partially automated driving mode of the motor vehicle.

In a method step of the method according to the invention, a rear-facing or rearward region, i.e. one behind the motor vehicle in the direction of travel, of all direction lanes detectable by means of the environment sensor system is monitored for objects by means of a rearward or rear-facing environment sensor system, i.e. one directed opposite the forward direction of travel towards the rear of the motor vehicle. In other words, the corresponding region can be scanned or captured by the environment sensor system, and objects located in this region can be detected using the resulting raw or sensor data. Such objects may be or include, for example, other road users, in particular other vehicles, which may also be referred to as third-party vehicles. The environment sensor system can be or comprise, for example, a radar device, a lidar device, a camera and/or other similar devices. Monitoring may be carried out continuously during operation of the vehicle or while the motor vehicle is driving or when an assistance system of the motor vehicle designed to carry out the method is activated. In other words, the monitoring can be carried out even before or independently of a lane change or a lane change intention of the driver. One or more adjacent lanes can be monitored on one or both sides of the lane that the motor vehicle is currently driving on.

In a further method step of the method according to the invention, detected objects are respectively assigned to the specific one of the direction lanes on which they are or appear to be located. In other words, the detected objects are thus localized or positioned with respect to the direction lanes at least to the extent possible, or as precisely as possible, on the basis of the raw or sensor data. For this purpose, the direction lanes can also be identified or detected, for example, by means of the or a further environment sensor system, for example on the basis of road or lane markings. Likewise, for example, a locally given number of direction lanes of the road can be determined automatically based on predetermined map data or the like.

In a further method step of the method according to the invention, the corresponding automatic direction lane assignment of the objects is classified as stable if, or as soon as, no switch has occurred in the object-specific direction lane assignments for the detected objects for at least a predetermined period of time and/or over at least a predetermined distance traveled, for example by the motor vehicle and/or the detected objects. In this case, the direction lane assignment, i.e. the spatial assignment of the detected objects to one of the direction lanes of the road in each case, can be carried out repeatedly in a regular manner, for example according to a recording or sampling frequency of the environment sensor system.

A switch in an object-specific direction lane assignment can then mean that a detected object is initially assigned to one of the direction lanes and assigned to another of the direction lanes at the next direction lane assignment, in particular without a continuous transition or without an intermediate phase in which the object is or has been detected or classified as changing its direction lane.

Likewise, a switch in the direction lane assignment in the present sense can only be present in the event of at least two such, in particular successive, in particular opposing, changes in the direction lane assignment of at least one specific object. Since relevant objects, in particular third-party vehicles, typically perform or can perform a lane change only slowly relative to the recording or sampling frequency of the environment sensor system, i.e. over a plurality of measurement or recording cycles, such switches in the direction lane assignments can be treated or used as an indication of an uncertain or inaccurate direction lane assignment, i.e. localization or positioning, of the detected objects. In turn, the absence of such switches can be treated as an indication of a correct, accurate and reliable direction lane assignment of the detected objects.

The classification of the direction lane assignment as stable can be carried out, for example, by automatically setting a corresponding flag in an operating or computer program of an assistance system or the like, used for carrying out the method according to the invention. The predetermined time period can be a sliding time window of predetermined length that always extends from the current time into the past. The direction lane assignment is therefore classified as stable if no switch of at least one object-specific direction lane assignment is or has been detected or identified within this time window and thus the direction lane assignments for all detected or tracked objects are or were stable at least over the predetermined time period.

Further, according to the method according to the invention, the automatic direction lane assignment is classified as unstable as soon as a switch occurs, i.e. is detected or identified, in at least one of the object-specific direction lane assignments. For example, the corresponding flag can be toggled, i.e. set to a different value or state.

According to the method according to the invention, for as long as the direction lane assignment is classified as stable, only objects assigned to the or other adjacent lanes are taken into account for supporting the lane change, i.e. the corresponding assistance function. In other words, objects or corresponding raw or sensor data assigned to the lane on which the motor vehicle is currently driving from a sub-region assigned to or corresponding to the lane currently being driven on can then be discarded or ignored. Thus, it is then only checked when necessary whether the at least one adjacent lane is free of objects that would prohibit a safe lane change of the motor vehicle onto or into this adjacent lane.

If a safe lane change is possible in light of the objects or raw or sensor data considered in accordance with at least one predetermined position criterion, a corresponding predetermined control signal is automatically output according to the method according to the invention. Such a control signal can, for example, enable a lane change and/or indicate or signal it as safe. For this purpose, for example, an optical, acoustic and/or haptic display or output device can be used, that is, appropriately controlled. Likewise, the control signal, for example, can be used to set or change a predetermined setting of a control unit, a steering device and/or other similar device. This can make, for example, manual steering of the motor vehicle in the adjacent lane more difficult or prevent it if such an action has been identified as unsafe due to at least one detected object. Further and/or other measures or operations can also be effected or initiated by the control signal.

The predetermined position criterion can relate to or check at least one position of the detected objects in the adjacent lane relative to the motor vehicle or its current position in the direction of travel, i.e. along the course of the direction lanes. For example, the position criterion can be satisfied if all detected objects assigned to the adjacent lane are located at least at a predetermined, for example speed-dependent, distance from the motor vehicle. In other words, the possibility of a safe lane change for the motor vehicle can be signaled if according to the available data no critical situation is present.

According to the method according to the invention, for example, a lane change can be enabled or indicated as possible if there are no objects, or at least no objects approaching the motor vehicle, within a predetermined distance of or within a predetermined area surrounding the motor vehicle. The distance or the surrounding area can be statically or dynamically defined, that is, for example, automatically defined or adjusted depending on a detection range of the environment sensor system, the road type, a relative speed between the detected objects and the motor vehicle and/or the like. In the opposite case, no lane change option is indicated or no lane change approval is given or even any corresponding warning issued if an object, in particular an object approaching the motor vehicle, was detected within the specified distance or within the specified surrounding area or if a critical situation according to a predetermined definition is present with regard to a lane change maneuver.

The method according to the invention can be carried out at regular intervals or continuously, that is, applied or at least partially iterated in a loop, while the motor vehicle is driving or in operation. This may relate to one, some or all of the above processes or method steps of the method according to the invention.

The method according to the invention can achieve longer or more frequent availability periods of the support function, i.e. a corresponding assistance function for lane changing, especially on at least substantially straight or straight-line route sections, in comparison to conventional solutions in which all direction lanes are constantly monitored for objects and the indication of the possibility of safe lane change is suppressed or prevented as soon as an object is detected in any of the direction lanes. The present invention can thus ensure that the signaling of the possibility of a safe lane change or an approval for enabling a lane change or the like is not prevented by objects that do not actually hinder a safe lane change.

Thus, for example, in situations in which a detected object is located behind the motor vehicle in the lane currently being driven on by this vehicle, or in a further direction lane different from this and the targeted adjacent lane, the appropriate assistance function can nevertheless be offered to support the driver to change lanes or optionally, the possibility of a safe lane change will be signaled. This allows better robustness and availability of the support function to be achieved.

The robustness of the method according to the invention is also achieved or supported in particular by the fact that the classification of the direction lane assignment is realized logically in the context of a While loop.

As soon as it is determined that under the current conditions the direction lane assignment is or can no longer take place in a stable manner, i.e. the actual position of the detected objects with respect to the direction lanes is no longer reliably determined or can be-actually or probably-determined, the objects, or corresponding raw or sensor data, assigned to the lane currently being driven on by the motor vehicle can be taken into account again to support the lane change. Thus, the method according to the invention can build on a corresponding previous method or use this as a fallback level. Thus, the method according to the invention can be used in a particularly simple and practical manner, without any associated restrictions or disadvantages compared to previous methods.

It may be provided that the method according to the invention is only used when driving on a motorway or a road with motorway-like or motorway-type design, or that the corresponding assistance or support function is only available, that is, can be activated there.

In a possible refinement of the present invention, a radar device is used as the environment sensor system of the motor vehicle or at least as part of the environment sensor system. With radar devices such as those available today, i.e. rear-mounted radars, it is often the case that detected objects appear to flicker or jump back and forth between different adjacent lanes. In the case of conventional assistance devices for lane change support, this can prevent a lane change from being approved. Since this can be prevented or reduced by means of the present invention, the use of a radar device as the environment sensor system or as part of the environment sensor system thus results in a particularly useful possible application for the present invention.

In a further possible embodiment of the present invention, the predetermined control signal is only output if at least one further predetermined condition is also satisfied. As such a further condition it may be specified in particular that the respective current speed of the motor vehicle be greater than a predetermined minimum speed and/or that a guideline, i.e. a broken line as part of the lane marking or lane boundary marking, be present or have been detected between the lane currently being driven on and the adjacent lane. Such a guideline can also be automatically detected, for example, by means of the environment sensor system or by means of an additional environment sensor system, for example a camera directed into the environment of the motor vehicle, or the like. If the further specified condition or at least one of multiple further specified conditions is not satisfied, the system can prevent a safe lane change from being signaled-optionally, independently of other conditions. Likewise, the check of the at least one predetermined condition can be carried out before or at the start of the method, in particular automatically in the background, i.e. without manual triggering or activation by the driver of the motor vehicle. Likewise, corresponding data which indicates whether the at least one predetermined condition is satisfied can be retrieved by one or more other assistance systems or via an on-board network of the motor vehicle when the assistance function described here for supporting lane changes is to be activated. If it is determined that the at least one predetermined condition is not satisfied, the corresponding assistance function is optionally not offered, and therefore cannot be activated. In this way, errors or hazardous situations due to a lack of accuracy or reliability of the automatic sensor-based detection of the environment or on unfavorable environmental conditions, such as a lack of roadside equipment, can be particularly effectively avoided.

In a further possible embodiment of the present invention, the respective approach speed to the motor vehicle is determined for each of the detected objects. In other words, the relative speed between each of the detected objects and the motor vehicle is determined. This can be carried out, for example, on the basis of raw or sensor data from the environment sensor system or by means of an additional environment sensor system. The output of the predetermined control signal, in particular a signaling of the possibility of a safe lane change or execution of the lane change, is then prevented if or as long as the approach speed of at least one detected object is greater than a predetermined threshold value. This can be carried out in particular regardless of which of the direction lanes the respective object is located on or whether the direction lanes have already been assigned for this object, i.e. the direction lane assignment has been carried out. The relative-speed-dependent prevention of the output of the control signal, in particular of the lane change approval, as proposed here, can be triggered in particular by objects rapidly approaching the motor vehicle within a predetermined distance from the motor vehicle. The predetermined distance can be a static variable or depend on the relative or approach speed. In the latter case, for a higher approach speed the output of the control signal can be prevented or suppressed at a greater distance than for a lower approach speed. Likewise, the threshold value for the approach speed can be dynamically specified, i.e. automatically adjusted, for example, depending on a current capture or detection range of the environment sensor system or the like. Thus, the threshold value can be automatically reduced in a predetermined manner as the capture or detection range decreases, and increased as the capture or detection range rises. The capture or detection range may depend, for example, on local environmental conditions, such as weather conditions, the degree of curviness of the road, any road boundaries interfering with the environment sensor system, or interfering objects in the region of the road and/or the like.

The optionally provided independence of the direction lane assignment of the object can take into account, for example, the risk that an object approaching in the lane currently being driven on by the motor vehicle with an approach speed at least similar to the predetermined threshold value might quickly or suddenly pull out into the adjacent lane, i.e. might start to overtake the motor vehicle.

In general, the relative speed between detected objects and the motor vehicle can thus be checked or taken into account as a further parameter or as a further condition in the method according to the invention. In this case it can be provided that, if at least one detected object has a relative speed above the or a predetermined threshold value, then no lane change option is signaled or enabled, that is, indicated or offered by the control signal. Instead, an appropriate warning or danger can then be signaled, for example.

Likewise, by taking the relative speed into account, however, it is also optionally possible to signal or enable a lane change option if, for example, the distance of a detected object from the motor vehicle according to the predetermined position criterion would be too small to allow a lane change, but this object, for example, is moving more slowly than the motor vehicle so that the distance between the object and the motor vehicle is increasing, or if the object is moving at the same speed as the vehicle or the approach speed of the object is less than a second predetermined threshold value. For example, this second predetermined threshold may be a few km/h, for example a maximum of 10 km/h or a maximum of 5 km/h or a maximum of 2 km/h, or a few percent, for example, a maximum of 8% or a maximum of 5% or a maximum of 2%, of the current speed of the motor vehicle.

By taking into account the relative or approach speed of the detected objects with respect to the motor vehicle, a situation-dependent and thus more flexible and more reliable implementation or application of the automatic lane change support can be realized.

In a further possible embodiment of the present invention, a course of the road is automatically determined. The direction lane assignment is then only classified as stable, if also, in addition to the condition that no switch of the object-specific direction lane assignments was detected, a local curviness of the road, i.e. the curvature of the road in a section currently being driven on by the motor vehicle, is below a predetermined threshold value. For example, the length of the section can be specified as a parameter value. The respective section may extend in the direction of travel of the motor vehicle up to a given length or distance in front of and/or behind the motor vehicle. In other words, the section may include a previous region, that is, the most recently driven region, and/or an upcoming region of the road, that is, the region of the road to be driven on next. The curviness of the road can be determined automatically, for example, on the basis of map data, by means of environment detection, on the basis of a trajectory or self-motion monitoring of the motor vehicle, on the basis of predictive route data and/or the like. The consideration of curviness proposed here is based on the recognition that in particularly curved road or route sections, the direction lane assignment, in particular radar-based, may be less reliable or more prone to errors than in straight, i.e. straight-line road or route sections, i.e. than in sections with a correspondingly lower degree of curviness. In addition, an effective capture or detection range of the environment sensor system for objects can be restricted by a correspondingly high degree of curviness of the road. Overall, the safety and reliability of the automatic support for lane changes can thus be further improved by the design of the present invention proposed here.

In a further possible embodiment of the present invention, a local traffic density in a current environment of the motor vehicle is determined automatically. The traffic density can correspond in particular to an object density, i.e. the density of the objects detected or to be detected. The direction lane assignment is classified as unstable if or as long as the local traffic density is greater than a predetermined threshold value. The local traffic density may be defined, for example, as traffic density within a predetermined region around the motor vehicle or up to a predetermined distance from the motor vehicle. The consideration of traffic density proposed here is based on the recognition that individual detection and tracking, in particular radar-based, and prediction of the behavior or motion of objects in the vicinity of the vehicle can be less accurate or less reliable in correspondingly high traffic density than in lower traffic density. The traffic density can be determined or estimated, for example, on the basis of raw or sensor data and/or at least one additional environment sensor system of the motor vehicle. Likewise, to determine the local traffic density, data or signals received for example by means of car-to-car communication from vehicles or road users from the respective environment of the vehicle, traffic or congestion information received via a wireless data connection and/or the like, can be used or taken into account.

In a further possible embodiment of the present invention, it is automatically determined whether an interfering object from a predetermined list of possible interfering objects is located in the current environment of the motor vehicle. This predefined list can include or specify interfering objects that can disrupt the detection of objects by means of the environment sensor system. If, or as long as, such an interfering object is located in the vicinity of the motor vehicle, the direction lane assignment is classified as unstable. Such interfering objects may be or include, for example, tunnels or tunnel walls, at least certain types or forms of crash barriers, posts, in particular metallic ones, road surface sections with unfavorable reflectivity, for example due to their material, condition, contamination, moisture, snow covering, ice covering or the like, or metal bridges or scaffolding spanning the road and/or other similar objects. Such interfering objects can interfere with radar-based object detection in particular. The interfering objects can be detected, for example, by means of a camera on the motor vehicle, in particular oriented to the front in the direction of travel, from predetermined map data and/or in other ways. By the design of the present invention proposed here, the safety and reliability of the signaling or approval of the possibility of a safe lane change can ultimately be further improved.

In a further possible embodiment of the present invention, the method is only carried out, in other words the assistance function for supporting a lane change is only offered, after an object has been detected by means of the environment sensor system at least once during the current driving or operating time of the motor vehicle. Such an at least one-time prior object detection can serve as proof of the functioning or operational readiness of the environment sensor system for object detection. In this case, it may be provided in particular that an object must have been detected at least a predetermined minimum distance from the motor vehicle at least once. This can ensure, for example, that the environment sensor system is not covered by dirt or snow or the like and that an apparent object detection is not due to such dirt or snow or the like, which is transported in the region of the environment sensor system along with the motor vehicle. In addition, by the at least one-time detection of an object required by the present invention, it can be ensured that the respective environment or weather conditions permit such object detection by means of the environment sensor system.

Before an object has been identified or detected at least once by means of the environment sensor system during the current driving or operating period of the motor vehicle, the assistance function for supporting a lane change can be deactivated or remain deactivated. In other words, the corresponding assistance function can be activated or switched on, that is to say, placed in an active state or standby state, by the driver of the motor vehicle only after an object has been detected or identified by means of the environment sensor system at least once.

By the design of the present invention proposed here, the safety and reliability of the described assistance function for supporting the driver of the motor vehicle with regard to a lane change can be further improved.

The conditions, parameters and measures specified in the various possible embodiments of the present invention for preventing the output of the predetermined control signal and/or the classifications of the direction lane assignment as stable or unstable can be prioritized in particular over the classification based on the occurrence of a switch in the object-specific direction lane assignments, for example, by overwriting them. This allows the safety and reliability of the method according to the invention to be further improved.

A further aspect of the present invention is an assistance system for a motor vehicle. The assistance system according to the invention has an input interface for capturing environmental data of an environment sensor system. Such environmental data may be or include raw or sensor data of the environmental sensor system and/or processed or pre-processed data. Furthermore, the assistance system according to the invention comprises a data processing device for processing the environmental data and an output interface for outputting at least one predetermined control signal. The assistance system according to the invention is configured for, in particular automatically or partially automatically, implementing at least one variant or embodiment of the method according to the invention. For this purpose, the data processing devices can include, for example, a processor device, for example, a microchip, microprocessor or microcontroller or the like, and a data memory connected to them. The data memory can then store a corresponding operating or computer program that implements or codes the procedures, measures, control instructions or method steps of the corresponding method. This operating or computer program can then be executable by the processor device to carry out the corresponding method, or cause or initiate its execution.

The assistance system according to the invention may in particular be or correspond to the assistance system mentioned in connection with the method according to the invention. Accordingly, the assistance system according to the invention may have some or all of the properties and/or features mentioned in this context. The assistance system according to the invention can also comprise the environment sensor system and/or an output or display device, by means of which the possibility of a safe lane change can be signaled.

A further aspect of the present invention is a motor vehicle which has an environment sensor system and an assistance system according to the invention. The environment sensor system is arranged or aligned for detecting a rear-facing, i.e. rearward, region around the motor vehicle. In this case, the environment sensor system can be part of the assistance system or directly or indirectly connected, to the assistance system, in particular to its input interface, for example via an on-board network of the vehicle. The motor vehicle according to the invention may in particular be or correspond to the motor vehicle cited in connection with the method according to the invention and/or in connection with the assistance system according to the invention. Accordingly, the motor vehicle according to the invention may have some or all of the properties and/or features mentioned in these contexts.

Further features of the invention can be derived from the following description of the figures and from the drawing. The features and feature combinations cited in the description above, and the features and feature combinations shown in the description of the figures below and/or in the figures alone are applicable not only in the respective combination indicated but also in other combinations or in isolation, without departing from the scope of the invention.

### IN THE DRAWINGS

FIG. 1 shows a detail of a schematic overview of a traffic scene for illustrating a method for supporting a lane change of a motor vehicle by means of an assistance system;

FIG. 2 shows a schematic drawing for illustrating the signaling of an inactive state of the assistance system;

FIG. 3 shows a schematic drawing for illustrating the signaling of an operationally ready state of the assistance system;

FIG. 4 shows a schematic drawing for illustrating the signaling of the existing possibility of a safe lane change to one side; and

FIG. 5 shows a schematic drawing for illustrating the signaling of a performance of the lane change.

Identical or functionally equivalent elements are labeled with the same reference signs in the figures.

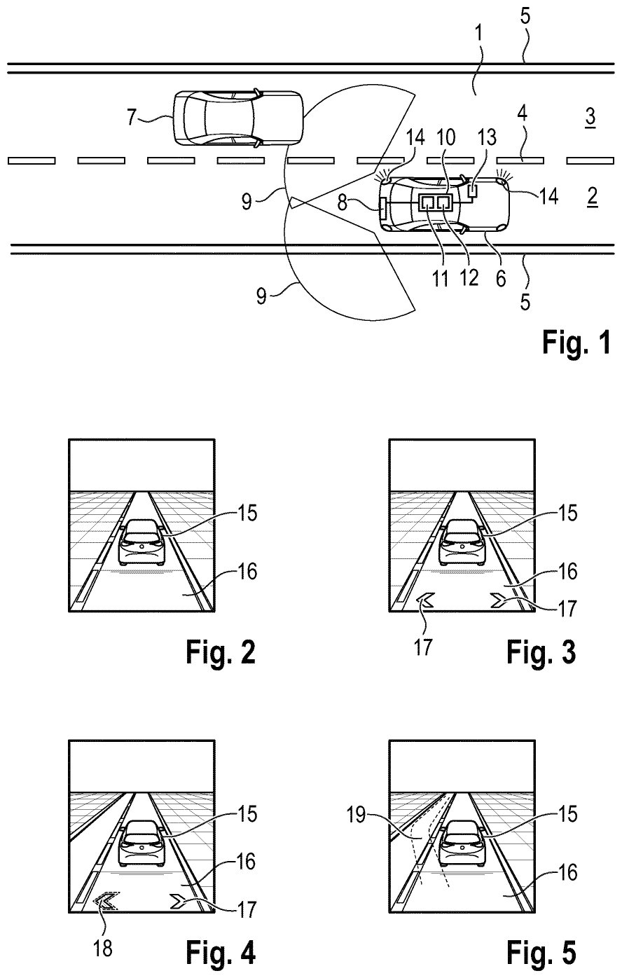

FIG. 1 shows a detail of a schematic overview illustrating a method for supporting a lane change of a vehicle, in particular in a manual driving mode of the vehicle. Also shown here is a section of a road 1 with a lane 2 and an adjacent lane 3 which adjoins the lane laterally and runs parallel to it. The lane 2 and the adjacent lane 3 are in this case direction lanes of the road 1 intended for the same direction of travel. The lane 2 and the adjacent lane 3 are separated by a guideline 4, so that a change between the lane 2 and the adjacent lane 3 is possible and permissible. At the sides, the lanes 2, 3 are bounded by road boundaries 5, for example, crash barriers or the like.

In the present case, a motor vehicle 6 drives on the lane 2, while on the adjacent lane 3 a third-party vehicle 7 approaches it from the rear. The motor vehicle 6 has a rear-facing, thus rearward-directed environment sensor system 8, the detection range 9 of which is schematically indicated here. Furthermore, the motor vehicle 6 has an assistance system 10 with a processor 11 and a data memory 12, which is configured for supporting a driver of the motor vehicle 6 during lane changes or lane change maneuvers. For this purpose, the motor vehicle 6 has a display device 13, which can be optionally used to signal to the driver that or whether a safe lane change is possible.

The driver of the motor vehicle 6 here can, for example, activate the assistance system 10 manually and then, for example, initiated by actuating a driving direction indicator 14 of the motor vehicle 6, be assisted by the assistance system 10 from the lane 2 to change to the adjacent lane 3 if the respective traffic situation permits this. For this purpose, the environment sensor system 8 can capture or scan the rear-facing region behind the motor vehicle 6 or monitor the region for objects. The environment sensor system 8 itself or the assistance system 10 can determine, based on corresponding sensor or environmental data, whether at least one object is located in the surrounding region, which would prohibit a safe lane change by the motor vehicle 6. As an example of such an object the third-party vehicle 7 can be detected. In order for the driver to receive a lane change approval, that is, for the opportunity for a safe lane change to be signaled by the assistance system 10, it can be specified, for example, that the in particular lateral and rearward environment of the motor vehicle 6 is free of corresponding objects. One or more further specified conditions can also be taken into account or evaluated.

It can be a challenge to detect and localize objects, the third-party vehicle 7 in this case, accurately and reliably, i.e. to determine the direction lane of the road 1 in which a particular object is located.

In the present case, the environment sensor system 8 is or comprises a radar device. The purpose of this radar device is to detect as many objects behind the motor vehicle 6 as possible in a clean and stable manner. However, in certain scenarios or situations it can happen that detected objects or their position will appear to flicker back and forth between the lane 2 that the motor vehicle 6 is driving on and the adjacent lane 3, so that no stable direction lane assignment for the respective object is possible. This can prevent a lane change approval or opportunity being assigned or signaled. In order that this does not happen when a safe lane change would actually be possible, if, for example, unlike the situation shown here, the third-party vehicle 7 behind the motor vehicle 6 is also located in the lane 2 and is moving in particular at a similar speed to the motor vehicle 6, the stability of the direction lane assignments, i.e. corresponding switches of the object-specific direction lane assignments of the detected objects, can be evaluated and taken into account.

Firstly, it can be determined, for example by means of a front-mounted sensor, in particular a forward facing camera, of the motor vehicle 6, and/or based on navigation or map data or the like, whether a curvature or curviness of the section or region of the road 1 the motor vehicle 6 is currently driving on is less than a predetermined limit value. If this is the case, a corresponding flag or status variable can be accordingly set automatically by the assistance system 10, for example. For example, it can be determined that the motor vehicle 6 is currently on a relatively straight or straight-line section of road. If this is the case, either a direction lane assignment of the objects detected by means of the environment sensor system 8 can then be carried out, or this possibly already completed direction lane assignment can be checked for switches within a sliding time window of predetermined length. In doing so it is determined whether the object-specific direction lane assignments of the detected objects were stable, i.e. constant, over a specified period of time, for example the last 5 s or the last 10 s or the like. If this is the case, i.e. if no switches have occurred in the object-specific direction lane assignments, then here also a corresponding flag or status variable can be accordingly set, for example by the assistance system 10.

The above-mentioned flags or status variables are automatically set to their or a different value or state if the local curvature or curviness of the road 1 reaches or exceeds the predetermined threshold value or if a switch or switching back and forth of the at least one object-specific direction lane assignment of the detected objects is detected.

Thus, as long as the motor vehicle 6 is moving on a straight-line road section and the direction lane assignment is classified as stable, then only the objects detected outside of the lane 2 on which the motor vehicle 6 is driving or only those assigned to the adjacent lane 3 are considered or evaluated—for example with regard to their position and/or relative speed with respect to the motor vehicle 6—in order to determine whether the option of a safe lane change exists and to signal this automatically by means of the display device 13 if appropriate.

As soon as it is determined, for example, by means of the environment sensor system 8, by means of the assistance system 10 and/or by means of an additional sensor system or assistance device of the motor vehicle 6, that conditions exist that lead to or can lead to the radar-based direction lane assignment for the detected objects ceasing to be stable, that is, the objects are not or will no longer be detected or localized reliably or in a stable manner, all detected objects or all environmental data for all direction lanes will be evaluated or taken into account again for supporting the lane change. In other words, no option of a safe lane change will be signaled if at least one relevant or critical object with regard to a lane change by the motor vehicle 6 has been detected by the environment sensor system 8, regardless of the position or direction lane assignment of the object.

For further illustration, FIG. 2, FIG. 3, FIG. 4 and FIG. 5 show schematic display of the kind that might be indicated or output by means of the display device 13 in various situations. In each case, a vehicle representation 15, that is, a schematic representation of the motor vehicle 6, and a road representation 16, that is, a schematic representation of the road 1, are shown.

The display in FIG. 2 can be output in a deactivated or inactive state of the assistance system 10, i.e. it can indicate a correspondingly deactivated or inactive state of the assistance system 10.

FIG. 3 illustrates a possible display in an operationally ready state of the assistance system 10. Readiness indicators 17 for lane change are shown here in both sideways directions. The readiness indicator 17 is in a passive state, which does not indicate the opportunity for a safe lane change but merely signals that the assistance system 10 is active, for example, it is permanently or automatically monitoring the environment for objects and opportunities for changing lanes upon a predetermined operating action or control by the driver of the motor vehicle 6. Such a predetermined operating action or control may be or comprise, for example, activation of the direction indicator 14.

FIG. 4 shows a possible display in a situation in which there is a possibility of a safe lane change. A corresponding lane change possibility indicator 18 is shown for this purpose. This may correspond, for example, to an active, for example, illuminated or color-coded or flashing, display of one of the readiness indicators 17.

FIG. 5 shows a possible display, for example, after an activation of the direction indicator 14 or during an execution of the lane change maneuver. A corresponding driving maneuver indicator 19 is shown here. In addition, in this situation, for example, by means of the display device 13, a warning signal can be output to the driver of the motor vehicle 6 to pay attention to the environment of the motor vehicle 6 before and during the lane change maneuver itself.

Overall, the examples described show how an improvement in the availability and robustness of an assisted lane change procedure can be implemented.

### LIST OF REFERENCE SIGNS

1 road

2 lane

3 adjacent lane

4 guideline

5 road boundary

6 motor vehicle

7 third party vehicle

8 environment sensor system

9 detection region

10 assistance system

11 processor

12 data memory

13 display device

14 driving direction indicator

15 vehicle representation

16 road representation

17 readiness indicator

18 lane change possibility indicator

19 driving maneuver indicator

1-10. (canceled)

11. A method supports a driver of a motor vehicle during forward travel of the motor vehicle on a road having a plurality of direction lanes with regard to a possible lane change from a lane on which the vehicle is currently driving to at least one detected adjacent lane, which comprises the steps of:
monitoring a rear-facing region of all detectable direction lanes for objects by means of a rearward-directed environment sensor system of the motor vehicle;
assigning each of the objects thereby detected to a specific one of the direction lanes on which the objects appear to be located;
classifying an automatic direction lane assignment as stable if no switch has occurred in object-specific direction lane assignments for the objects detected for at least a predetermined period of time and/or distance;
classifying the automatic direction lane assignment as unstable as soon as a switch occurs in at least one of the object-specific direction lane assignments;
taking into account only the objects assigned to at least one adjacent lane for supporting the lane change as long as the automatic direction lane assignment is classified as stable; and
outputting a predetermined control signal if a safe lane change is possible in accordance with a predetermined position criterion in view of the objects taken into account.

12. The method according to claim 11, which further comprises using a radar device as the rearward-directed environment sensor system of the motor vehicle.

13. The method according to claim 11, which further comprises outputting the predetermined control signal only if at least one further predetermined condition is satisfied.

14. The method according to claim 11, wherein for the objects detected for which a respective speed of approach to the motor vehicle is determined and an output of the predetermined control signal, is prevented, if an approach speed of at least one detected object is greater than a predetermined threshold value.

15. The method according to claim 11, which further comprises determining a course of the road and the automatic direction lane assignment is classified as stable only if a local curviness of the road in a section on which the motor vehicle is driving is less than a predetermined threshold value.

16. The method according to claim 11, which further comprises determining a local traffic density in an environment of the motor vehicle and the automatic direction lane assignment is classified as unstable if the local traffic density is greater than a predetermined threshold value.

17. The method according to claim 11, wherein it is determined whether an interfering object from a predetermined list of possible interfering objects, which can interfere with a detection of the objects by means of the rearward-directed environment sensor system, is located in an environment of the motor vehicle and, if the interfering object is confirmed, an object-specific direction lane assignment is classified as unstable.

18. The method according to claim 11, which further comprises carrying out the method only after an object has been detected at least once by means of the rearward-directed environment sensor system during a current journey of the motor vehicle.

19. The method according to claim 11, which further comprises outputting the predetermined control signal only if at least one further predetermined condition is satisfied, namely the at least one further predetermined condition is that a current speed of the motor vehicle is greater than a predetermined minimum speed and/or that a guideline between the lane on which the vehicle is currently driving and an adjacent lane has been detected.

20. The method according to claim 11, wherein for the objects detected for which a respective speed of approach to the motor vehicle is determined and an output of the predetermined control signal, which signals a possibility of a safe lane change or execution of the lane change, is prevented, if an approach speed of at least one detected object is greater than a predetermined threshold value, irrespective of which of the direction lanes a respective object is located on.

21. The method according to claim 11, which further comprises carrying out the method only after an object, having at least at a predetermined minimum distance from the motor vehicle, has been detected at least once by means of the rearward-directed environment sensor system during a current journey of the motor vehicle.

22. An assistance system for a motor vehicle, the assistance system comprising:
an input interface for detecting environment data of an environment sensor system;
a data processor for processing the environment data;
an output interface for outputting a predetermined control signal; and
the assistance system is configured to execute the method according to claim 11.

23. A motor vehicle, comprising:
an environment sensor system disposed for detecting a rear-facing environment region; and
the assistance system according to claim 22.
